(19) United States
(12) Patent Application Publication
(10) Pub. No.: US 2023/0169316 A1
(43) Pub. Date: Jun. 1, 2023

(54) Indexing Operations In Neural Network Processor

(71) Applicant: Apple Inc., Cupertino, CA (US)

(72) Inventor: Christopher L. Mills, Saratoga, CA (US)

(21) Appl. No.: 17/538,138

(22) Filed: Nov. 30, 2021

(51) Int. Cl. G06N 3/063; G06F 7/78

(52) U.S. Cl. CPC G06N 3/063; G06F 7/78

(57) ABSTRACT

Embodiments of the present disclosure relate to indexing in a neural processor circuit. The neural processor circuit includes multiple neural engine circuits and a data processor circuit directly coupled to at least one of the neural engine circuits. The at least one neural engine circuit performs a convolution operation on input data to generate output data. The data processor circuit includes a buffer memory and an indexing circuit coupled to the buffer memory. The buffer memory stores an index tensor and the output data as a source tensor. The indexing circuit fetches a portion of the source tensor from the buffer memory by referencing the index tensor representing indexing information into the portion of the source tensor.

### BACKGROUND

### 1. Field of the Disclosure

The present disclosure relates to a circuit for performing operations related to neural networks, and more specifically to a circuit for performing indexing operations in a neural network processor.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of the CPU as well as increase the overall power consumption.

### SUMMARY

Embodiments relate to indexing operations in a neural processor circuit. The neural processor circuit includes multiple neural engine circuits and a data processor circuit directly coupled to at least one of the neural engine circuits. The at least one neural engine circuit performs a convolution operation on input data to generate output data. The data processor circuit includes a buffer memory and an indexing circuit coupled to the buffer memory. The buffer memory stores an index tensor and the output data as a source tensor. The indexing circuit fetches a portion of the source tensor from the buffer memory by referencing the index tensor representing indexing information into the portion of the source tensor.

### BRIEF DESCRIPTION OF THE DRAWINGS

FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a block diagram of a planar engine in the neural processor circuit, according to one embodiment.

FIG. 6 is a block diagram of an indexing circuit in a data processor circuit of the neural processor circuit, according to one embodiment.

FIG. 7 is a flowchart illustrating a method of performing an indexing operation in the neural processor circuit, according to one embodiment.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to indexing operations in a neural processor circuit. An indexing operation can be used for dynamic slicing and data indirection, and enables indirect access of elements in one axis or along one dimension of a source tensor stored in a data processor circuit of the neural processor circuit. The indexing operation allows the data processor circuit to decide which elements in the source tensor to fetch and send to a planar engine circuit or to at least one neural engine circuit for further processing, based on a result of a previous operation (e.g., a reduction operation by the planar engine circuit). Indexing and data indirection can be utilized in various algorithms, such as in the non-maximum suppression algorithm where a single box of pixel data (out of multiple boxes of pixel data stored in the buffer memory) is indexed and fetched from the buffer memory based on a result of a reduction operation (e.g., ArgMax/Min operation) and broadcasted to neural engine circuits for further processing. The data processor circuit includes a buffer memory and an indexing circuit coupled to the buffer memory for performing indexing operations on data (e.g., source tensors) stored in the buffer memory. The buffer memory may also store an index tensor generated by, e.g., the planar engine circuit. Components of the index tensor may be results of a reduction operation performed by the planar engine circuit. The indexing circuit may fetch a portion of a source tensor from the buffer memory (e.g., elements of the source tensor along one axis or dimension) by referencing the index tensor that represents indexing information into the portion of the source tensor. The indexing circuit may provide the fetched portion of the source tensor as input data to the at least one neural engine circuit or the planar engine circuit.

### Exemplary Electronic Device

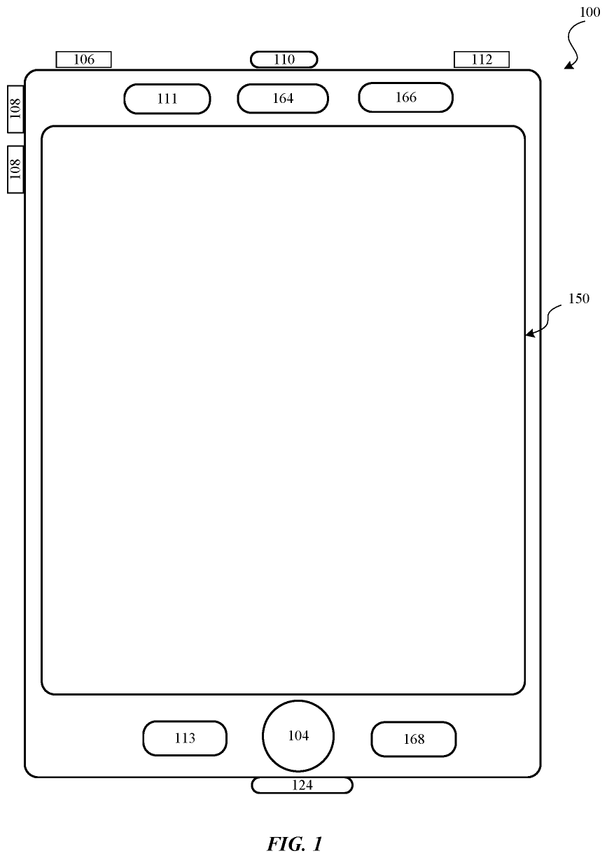

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

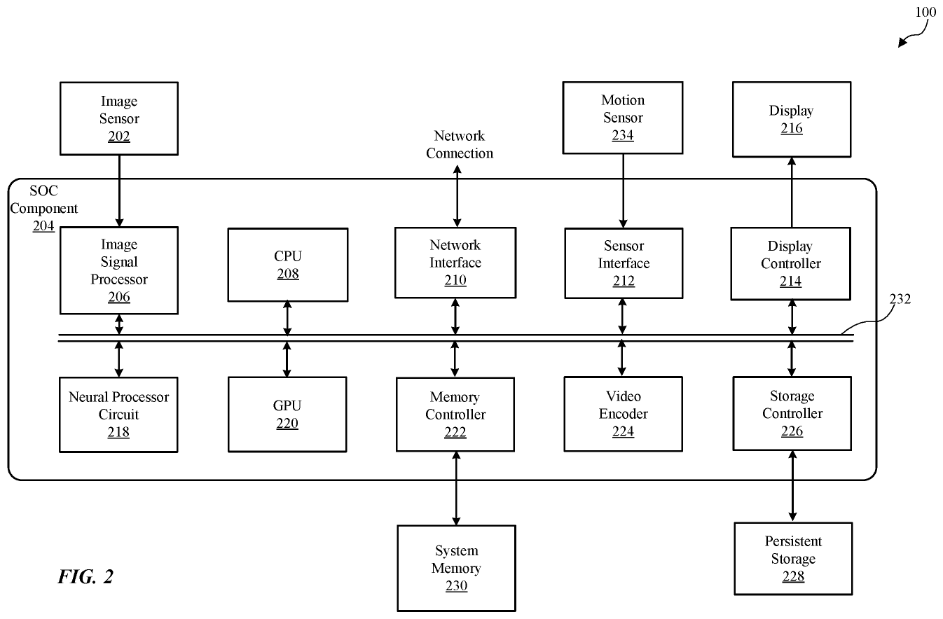

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

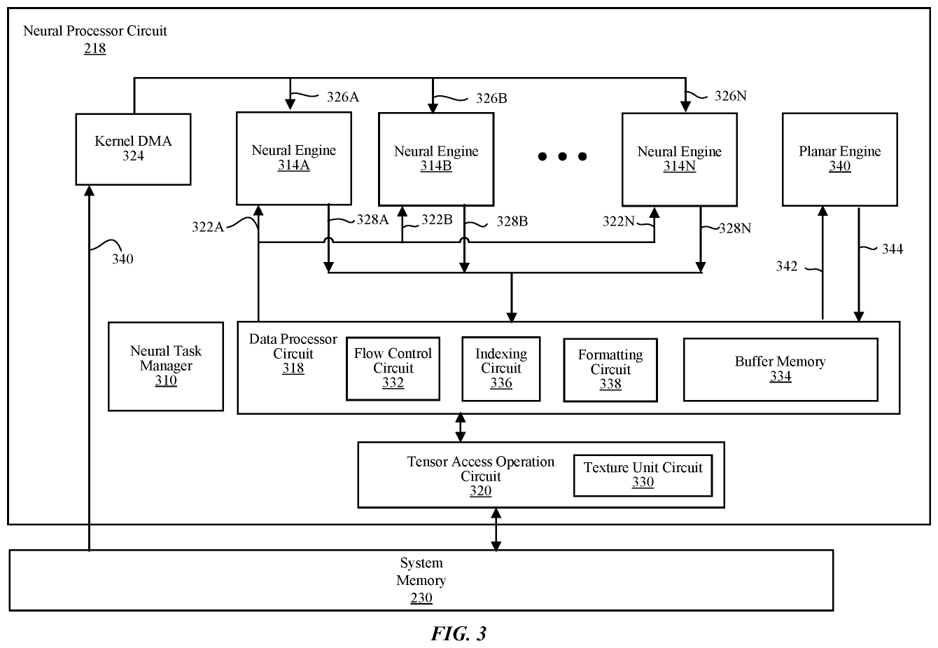

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, ISP 206, persistent storage 228, system memory 230 or other sources such as network interface 210 or GPU 220. The output of neural processor circuit 218 may be provided to various components of device 100 such as ISP 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to ISP 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

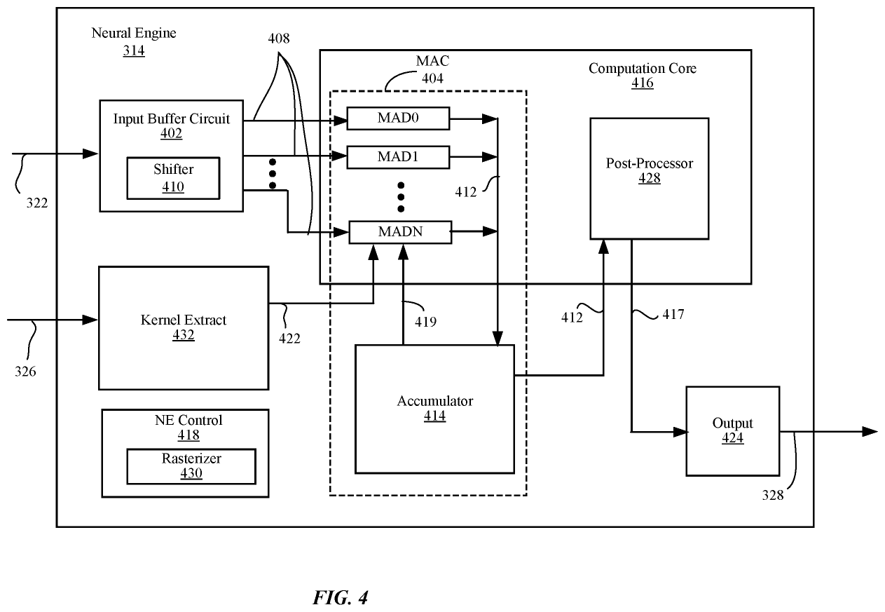

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

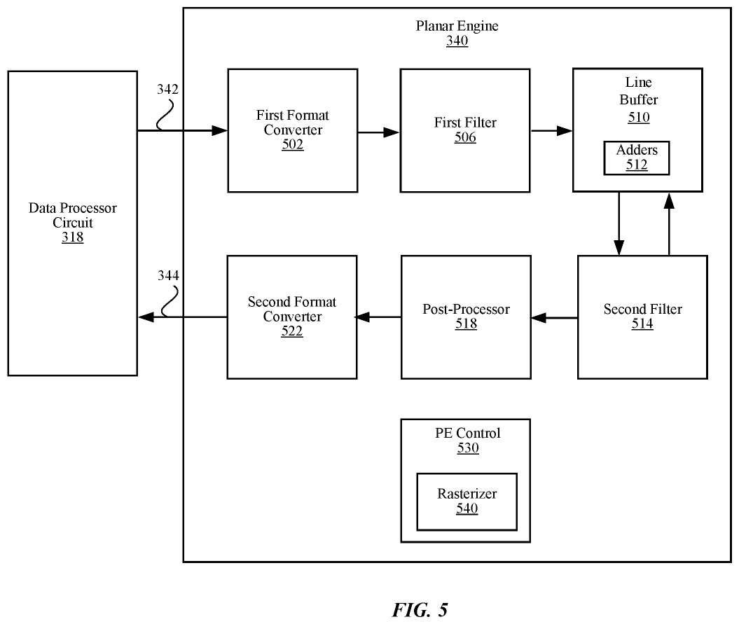

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar). The operations of planar engine 340 will be discussed in further detail below with reference to FIG. 5.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data. Data of neural processor circuit 218 includes input data that is transmitted from another source such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data from a source (e.g., system memory 230) and sends kernel data 326A through 326N to each of neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a flow control circuit 332, a buffer memory 334, an indexing circuit 336 coupled to buffer memory 334, and a formatting circuit 338 coupled to indexing circuit 336. Buffer memory 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In one embodiment, buffer memory 334 is embodied as a non-transitory memory that can be accessed by neural engines 314 and planar engine 340. Buffer memory 334 may be a direct memory access buffer that stores data of a machine learning model of device 100 without involvement of CPU 208. Buffer memory 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer memory 334 may also store input data 342 and output data 344 of planar engine 340 and allow the exchange of data between neural engine 314 and planar engine 340. For example, one or more output data 328A through 328N of neural engines 314 are used as input data 342 to planar engine 340. Likewise, output data 344 of planar engine 340 may be used as input data 322A through 322N of neural engines 314. The inputs of neural engines 314 or planar engine 340 may be any data stored in buffer memory 334. For example, in various operating cycles, the source datasets from which one of the engines fetches as inputs may be different. The input of an engine may be an output of the same engine in previous operating cycles, outputs of different engines, or any other suitable source datasets stored in buffer memory 334. Also, a dataset in buffer memory 334 may be divided and sent to different engines for different operations in the next operating cycle. Two datasets in buffer memory 334 may also be joined for the next operation.

Flow control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Flow control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to planar engine 340 to direct planar engine 340 to program itself for operating in one of multiple operation modes.

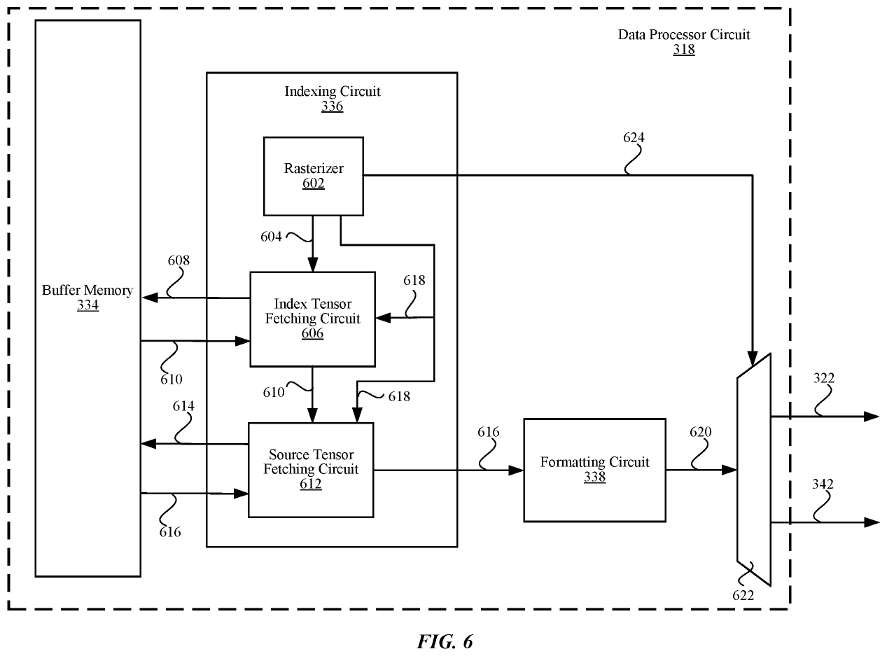

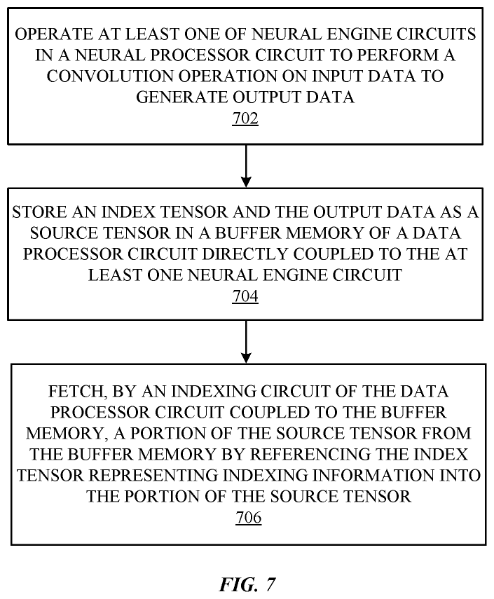

Indexing circuit 336 may perform indexing operations in neural processor circuit 218. Indexing circuit 336 may fetch a portion of a source tensor from buffer memory 334 (e.g., elements of one axis or dimension of the source tensor) by referencing an index tensor in buffer memory 334 representing indexing information into the portion of the source tensor. The source tensor may be generated by neural engine 314 and written into buffer memory 334 as part of output data 328. Alternatively, the source tensor may be generated by planar engine 340 and written into buffer memory 334 as part of output data 344. In one or more embodiments, the index tensor is generated by planar engine 340 and written into buffer memory 334 as part of output data 344. An indexing operation performed by indexing circuit 336 may allow a source of planar engine 340 (e.g., input data 342) to be offset by a scalar value that is also fetched from buffer memory 334 (e.g., as part of the index tensor). Formatting circuit 338 may receive the fetched portion of the source tensor from indexing circuit 336, and perform formatting and/or aligning of the fetched portion of the source tensor to generate an aligned version of the source tensor for, e.g., at least one neural engine 314 or planar engine 340. Indexing operations may be applied to reads of planar engine 340 (e.g., input data 342) for all operations at planar engine 340 except pooling and ternary operations. A structure and operations of indexing circuit 336 and formatting circuit 338 will be discussed in further detail below with reference to FIG. 6 and FIG. 7.

The data of neural processor circuit 218 stored in buffer memory 334 may be part of, among others, image data, histogram of oriented gradients (HOG) data, audio data, metadata, output data 328 of a previous operating cycle of neural engine 314, and other processed data received from other components of SOC component 204.

Tensor access operation circuit 320 is a circuit that directly access system memory 320 for fetching input data from system memory and writing output data into system memory 230. Tensor access operation circuit 320 may include a read circuit that receives a segment of the input data (e.g., tensor) from system memory 230 for further storage into buffer memory 334. Tensor access operation circuit 320 may further include a write circuit that forwards data from buffer memory 334 to system memory 230. In one embodiment, the direct memory access nature of tensor access operation circuit 320 allows tensor access operation circuit 320 to fetch and write data directly from system memory 230 without the involvement of CPU 208. Tensor access operation circuit 320 includes a texture unit circuit 330 for fetching the segment of the input data (e.g., tensor) from system memory 230 and for processing the tensor before sending the tensor to buffer memory 334.

### Example Neural Engine Architecture

FIG. 4 is a block diagram of neural engine 314, according to one embodiment. Neural engine 314 performs various operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator circuit 414 and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Kernel extract circuit 432 is a circuit that receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate register in multiply-add (MAD) circuits of computation core 416. In other embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include MAD circuits MAD0 through MADN and a post-processor 428. Each of MAD circuits MAD0 through MADN may store an input value in segment 408 of the input data and a corresponding kernel coefficient in kernel coefficients 422. The input value and the corresponding kernel coefficient are multiplied in each of MAD circuits to generate a processed value 412.

Accumulator circuit 414 is a memory circuit that receives and stores processed values 412 from MAD circuits. The processed values stored in accumulator circuit 414 may be sent back as feedback information 419 for further multiply and add operations at MAD circuits or sent to post-processor 428 for post-processing. Accumulator circuit 414 in combination with MAD circuits form a multiply-accumulator (MAC) 404. In one or more embodiments, accumulator circuit 414 may have subunits (or batches) where each subunit sends data to different components of neural engine 314. For example, during an operating cycle, data stored in a first subunit of accumulator circuit 414 is sent to MAC 404 while data stored in a second subunit of accumulator circuit 414 is sent to post-processor 428.

Post-processor 428 is a circuit that performs further processing of values 412 received from accumulator circuit 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at post-processor 428 is bypassed. For example, the data in accumulator circuit 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed during a prior operating cycle of neural engines 314 having a size that produces output values that fit into accumulator circuit 414 of neural engine 314 during a single operating cycle of computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior operating cycle of planar engine 340 that can be processed simultaneously at planar engine 340.

Rasterizer 430 may perform the operations associated with dividing the input data into smaller units (segments) and regulate the processing of the smaller units through MACs 404 and accumulator circuit 414. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., kernel DMA 324, buffer DMA 320, buffer memory 334, planar engine 340) may also have their corresponding rasterizers to monitor the division of input data and the parallel computation of various segments of input data in different components.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Planar Engine

FIG. 5 is a block diagram of planar engine 340, according to one embodiment. Planar engine 340 is a circuit that is separated from neural engines 314 and can be programmed to perform in different modes of operations. For example, planar engine 340 may operate in a pooling mode that reduces the spatial size of data, in a reduction mode that reduces the rank of a tensor, in a gain-and-bias mode that provides a single-pass addition of bias and scaling by a scale factor, and in an elementwise mode that includes elementwise operations. For this purpose, planar engine 340 may include, among other components, a first format converter 502, a first filter 506 (also referred to herein as “multi-mode horizontal filter 506”), a line buffer 510, a second filter 514 (also referred to herein as “multi-mode vertical filter 514”), a post-processor 518, a second format converter 522, and a planar engine (PE) control 530 (includes rasterizer 540). Planar engine 340 may include fewer components or further components not illustrated in FIG. 5. Each component in planar engine 340 may be embodied as a circuit or a circuit in combination with firmware or software.

Input data 342 of planar engine 340 may be fetched from one or more source datasets that are saved in data processor circuit 318. If a dataset to be processed by planar engine 340 is larger than a work unit of data that can be simultaneously processed by planar engine 340, such dataset may be segmented into multiple work units for reading as input data 342 to planar engine 340. Depending on the mode of planar engine 340, input data 342 may include data from one or more source datasets. The source dataset described herein refers to different data saved in neural processor circuit 218 for processing. Different components of neural processor circuit 218 may generate or transmit data that is saved in data processor circuit 318. For example, neural engines 314, planar engine 340 (which generated data in a previous operation cycle), and system memory 230 may generate or transmit different datasets that are saved in different memory locations of data processor circuit 318. Various source datasets may represent different tensors. In an operation cycle of planar engine 340, different source datasets may be fetched together as input data 342. For example, in an elementwise mode that involves the addition of two different tensors to derive a resultant tensor, the input data 342 may include data from two different source datasets, each providing a separate tensor. In other modes, a single source dataset may provide input data 342. For example, in a pooling mode, input data 342 may be fetched from a single source dataset.

First format converter 502 is a circuit that performs one or more format conversions on input data 342 in one format (e.g., a format used for storing in buffer memory 334) to another format for processing in subsequent components of planar engine 340. Such format conversions may include, among others, the following: applying a ReLU function to one or more values of input data 342, converting one or more values of input data 342 to their absolute values, transposing a tensor included in the sources, applying gain to one or more values of input data 342, biasing one or more values of input data 342, normalizing or de-normalizing one or more values of input data 342, converting floating-point numbers to signed or unsigned numbers (or vice versa), quantizing numbers, and changing the size of a tensor such as by broadcasting a value of a tensor in one or more dimensions to expand the rank of the tensor. The converted input data 342 and unconverted input data 342 to planar engine 340 are collectively referred to herein as “a version of the input data.”

First filter 506 is a circuit that performs a filtering operation in one direction. For this purpose, first filter 506 may include, among other components, adders, comparators, and multipliers. The filtering performed by first filter 506 may be, for example, averaging, choosing a maximum value or choosing a minimum value. When averaging, adders are used to sum the values of input data 342 and a weighting factor may be applied to the sum using a multiplier to obtain the average as the resultant values. When selecting maximum and minimum values, the comparators may be used in place of the adders and the multipliers to select the values.

Line buffer 510 is a memory circuit for storing the result such as one or more intermediate data obtained from first filter 506 or second filter 514. Line buffer 510 may store values of different lines and allows access from second filter 514 or other downstream components to fetch the intermediate data for further processing. In some modes, line buffer 510 is bypassed. Line buffer 510 may also include logic circuits to perform additional operations other than merely storing the intermediate data. For example, line buffer 510 includes adder circuits 512, which in combination with memory component, enables line buffer 510 to function as an accumulator that aggregates data generated from the results of first filter 506 or second filter 514 to separately store aggregated data of a dimension not to be reduced.

Similar to first filter 506, second filter 514 performs filtering operations but in a direction different from first filter 506. For this purpose, second filter 514 may include, among other components, adders, comparators, and multipliers. In the pooling mode, first filter 506 performs filtering operation in a first dimension, while second filter 514 performs filtering operation in a second dimension. In other modes, first filter 506 and second filter 514 may operate differently. In a reduction mode, for example, first filter 506 performs elementwise operations while second filter 514 functions as a reduction tree to aggregate values of data.

Post-processor 518 is a circuit that performs further processing of values fetched from other upstream components. Post-processor 518 may include specialized circuits that are efficient at performing certain types of mathematical computations that might be inefficient to perform using a general computation circuit. Operations performed by post-processor 518 may include, among others, performing square root operations and inverse of values in a reduction mode. Post-processor 518 may be bypassed in other operation modes.

Second format converter 522 is a circuit that converts the results of preceding components in planar engine 340 from one format to another format for output data 344. Such format conversions may include, among others, the following: applying a ReLU function to the results, transposing a resultant tensor, normalizing or de-normalizing one or more values of the results, and other number format conversions. Output data 344 may be stored in data processor circuit 318 as the output of neural processor circuit 218 or as inputs to other components of neural processor circuit 218 (e.g., neural engine 314).

PE control 530 is a circuit that controls operations of other components in planar engine 340 based on the operation mode of planar engine 340. Depending on the different modes of operation, PE control 530 programs register associated with the different components in planar engine 340 so that the programmed components operate in a certain manner. The pipeline of components or connections between the components in planar engine 340 may also be reconfigured. In the pooling mode, for example, data processed at by first filter 506 may be stored in line buffer 510 and then be read by second filter 514 for further filtering. In the reduction mode, however, data is processed by first filter 506, then processed at second filter 514 and then accumulated in line buffer 510 that is programmed as an accumulator. In the elementwise mode, line buffer 510 may be bypassed.

PE control 530 also includes a rasterizer 540 that tracks the current task or process loop being processed at planar engine 340. Rasterizer 540 is a circuit that tracks units or segments of input data and/or loops for processing the input data in planar engine 340. Rasterizer 540 may control the fetch of segments to planar engine 340 in each operation cycle and may monitor the size and rank of each segment being processed by planar engine 340. For example, smaller segments of a dataset may be fetched as input data 342 in a raster order for processing at planar engine 340 until all segments of the source dataset are processed. In fetching the segments, rasterizer 540 monitors the coordinate of the segment in the dataset. The manner in which a dataset is segmented into input data 342 for processing at planar engine 340 may be different compared to how a dataset is segmented into input data 328 for processing at neural engines 314.

The dataset for processing at planar engine 340 may be larger than the capacity of planar engine 340 that can be processed in a single operation cycle. In such case, planar engine 340 fetches different segments of the dataset as input data 342 in multiple operating cycles. The fetched segment may partly overlap with a previously fetched segment and/or a next segment to be fetched. In one embodiment, the portion of overlapping data is fetched only once and reused to reduce the time and power consumption cost of planar engine 340 in fetching data.

### Example Indexing Circuit in Data Processor Circuit

FIG. 6 is a block diagram of indexing circuit 336 in data processor circuit 318 for fetching a portion of a source tensor from buffer memory 334, according to one embodiment. Indexing circuit 336 may include, among other components, a rasterizer 602, an index tensor fetching circuit 606 coupled to rasterizer 602, and a source tensor fetching circuit 612 coupled to index tensor fetching circuit 606.

Rasterizer 602 is a task descriptor circuit that generates one or more index values 604 for referencing an index tensor 610 previously stored in buffer memory 334. One or more index values 604 generated by rasterizer 602 may be passed onto index tensor fetching circuit 606. In data processor circuit, a rasterizer would track the data being written to or written out of buffer memory 334. In addition to tracking data (e.g., work units, slices, tensors, etc.) being stored and read from data processor circuit 318, rasterizer 602 may track the data being written to or written out of buffer memory 334. Rasterizer 602 may be part of indexing circuit 336 (as shown in FIG. 6), or may be a standalone circuit of data processor circuit 318. Alternatively or additionally, rasterizer 602 may be implemented as a software component or a firmware component.

Index tensor fetching circuit 606 is a circuit that fetches index tensor 610 from buffer memory 334. Index tensor fetching circuit 606 may receive one or more index values 604 from rasterizer 602, and produce one or more address values 608 for referencing index tensor 610 in buffer memory 334. Index tensor fetching circuit 606 may fetch one or more index components of index tensor 610 from buffer memory 334 using one or more address values 608. Index tensor 610 may be a multi-dimensional (e.g., five-dimensional) tuple with index components representing, e.g., width, height, channel, depth, and group of the source tensor in buffer memory 334. Each index component in index tensor 610 may represent indexing information for referencing a corresponding portion (axis or dimension) of the source tensor in buffer memory 334. Each index component in index tensor 610 may be, e.g., U16 (unsigned 16-bit) value, stored as a 16-bit quantity in buffer memory 334. Index components in index tensor 610 may be produced from FP16 (16-bit floating-point) data by, e.g., scaling integers in the range 0, 1, . . . , 2048 by 2⁻¹⁴. Alternatively, index components in index tensor 610 may be directly produced by planar engine 340 as a result of a reduction operation (e.g., ArgMax/Min operation) applied on at least a portion of input data 342. Once one or more index components of index tensor 610 are fetched from buffer memory 334, index tensor fetching circuit 606 may pass the fetched one or more index components of index tensor 610 onto source tensor fetching circuit 612.

Source tensor fetching circuit 612 is a circuit that fetches a portion of the source tensor from buffer memory 334 as a source surface 616 by referencing at least one index component 614 in index tensor 610 (e.g., stored locally in source tensor fetching circuit 612) representing indexing information into the portion (e.g., axis or dimension) of the source tensor. In a first indexing mode (e.g., as defined by a first value of indexing mode bits 618 generated by rasterizer 602), source tensor fetching circuit 612 may perform a straight indirection in order to fetch source surface 616 from buffer memory 334. In the first indexing mode, source tensor fetching circuit 612 may fetch elements of the source tensor along an axis (dimension) of the source tensor as source surface 616 that are indexed by at least one index component 614 in index tensor 610. Source surface 616 fetched from buffer memory 334 may represent a version of the source tensor scrambled along the indexed axis. Source surface 616 may be passed onto formatting circuit 338 for further processing.

In a second indexing mode (e.g., as defined by a second value of indexing mode bits 618 generated by rasterizer 602), source tensor fetching circuit 612 may perform a slicing operation on the source tensor in buffer memory 334 when fetching source surface 616. In the second indexing mode, source tensor fetching circuit 612 may fetch source surface 616 by fetching a slice of the source tensor in buffer memory 334 along an axis (dimension) of the source tensor starting from an offset value (e.g., scalar value) obtained from index tensor 610 (e.g., index component 614 in index tensor 610), where the slice is of a size that fits into buffer memory 334. The offset value may be used as a dynamic offset to fetch a particular set of samples from an axis of the source tensor in buffer memory 334.

In the second indexing mode, a per-batch scalar value from index tensor 610 may be applied as an offset to the source tensor in buffer memory 334 along an axis of the source tensor that is specified by, e.g., indexing mode bits 618. Instead of fetching elements y=0, 1, . . . , Hin−1 of the source tensor, source tensor fetching circuit 612 may fetch elements y=Val, Val+1, . . . , Val+Hin−1 as a fetched slice of the source tensor, where indexing mode bits 618 enable slicing along Y (height) dimension and Val is an offset value fetched from index tensor 610. The fetched slice of source tensor may be passed onto formatting circuit 338 as source surface 616 for further processing.

A maximum value of index component 614 (e.g., MaxIndex) that can be read from index tensor 610 may be configurable. The effect of configuring MaxIndex can be to clamp a value of index component 614 read from index tensor 610. This can limit an extent of the source tensor in the event that index tensor 610 contains out-of-bound index components (indexes). In the first indexing mode, out-of-range index components 614 in index tensor 610 may cause source tensor fetching circuit 612 to fetch a value from buffer memory 334 at Src[MaxIndex]. Thus, if index tensor 610 was initialized with a series of numbers that eventually exceeded MaxIndex, then edge values in source surface 616 fetched from buffer memory 334 would be replicated to be e.g., MaxIndex−1, MaxIndex, MaxIndex, MaxIndex, etc., while index tensor 610 may have arbitrary values of index components 614. In the second indexing mode, instead of performing edge-replication along a slice of the source tensor in buffer memory 334, an origin of the slice may be constrained so that the entire slice is constrained to be inside index tensor 610. For example, if a value of Idx[0] index component in index tensor 610 is larger than MaxIndex, then the slice of the source tensor fetched from buffer memory 334 may start at, e.g., MaxIndex and end at MaxIndex+Hin−1.

Formatting circuit 338 is a circuit that applies certain processing onto source surface 616 fetched from buffer memory 334. Formatting circuit 338 may perform a transpose operation on elements of source surface 616 to generate a processed (transposed) version of source tensor 620. Alternatively or additionally, formatting circuit 338 may perform formatting and aligning of source surface 616 to generate processed (aligned) version of source tensor 620. Processed version of source tensor 620 generated by formatting circuit 338 may be passed onto demultiplexer 622.

Demultiplexer 622 may broadcast processed version of source tensor 620 as a portion of input data 322 to neural engines 314 in accordance to a first value of a select bit 624 generated, e.g., by rasterizer 602. Alternatively, demultiplexer 622 may send processed version of source tensor 620 as a portion of input data 322 to a specific neural engine 314. At least one neural engine 314 may receive input data 322 that include processed version of source tensor 620, and perform at least one convolution operation on at least a portion of processed version of source tensor 620 to generate output data 328 that may be written back into buffer memory 334. Furthermore, demultiplexer 622 may send processed version of source tensor 620 as a portion of input data 342 to planar engine 340 based on a second value of select bit 624 generated, e.g., by rasterizer 602. Planar engine 340 may receive input data 342 that include processed version of source tensor 620, and perform a planar operation on at least a portion of processed version of source tensor 620 to generate a planar version of source tensor. Planar engine 340 may then write back the planar version of source tensor into buffer memory 334 as output data 344.

Indexing mode bits 618 may include at least two types of bits that can be set independently—index broadcasting bits and source broadcasting bits, thus providing three different indexing modes: indirection, slicing and broadcasting. In the case of source broadcasting mode, a single value may be fetched from the source tensor in buffer memory 334, which is then replicated to an output extent, e.g., to source surface 616 fetched by source tensor fetching circuit 612. In the case of index broadcasting mode, a single index value i may be fetched from index tensor 610 in buffer memory 334, which may be then replicated as a sequence of index values 614, e.g., i, i+1, i+2, i+3, etc. used for fetching source surface 616 from buffer memory 334. Index components in index tensor 610 may be batched by, e.g., group and depth dimensions. Thus, index tensor 610 may be, e.g., a NumGroups×1×1×Dout×Cout tensor, where NumGroups is a number of convolution groups, Dout is a surface depth (in planes) and Cout is a number of output channels per group. Index tensor 610 may be also broadcasted in Z (depth) dimension or C (channel) dimension, as defined and controlled by corresponding values of indexing mode bits 618. Additionally or alternatively, a transpose operation (e.g., width-to-channel transpose operation) may be applied to index tensor 610 resulting into, e.g., a NumGroups×Cout×1×Dout×1 tensor, as defined and controlled by corresponding values of indexing mode bits 618. Broadcasting and/or transpose of source surface 616 fetched from buffer memory 334 may occur after indexing, e.g., at formatting circuit 338. Thus, if the source broadcasting bits of indexing mode bits 618 also enable source broadcasting in Y (height) dimension, then source surface 616 fetched from buffer memory 334 would have Hin copies of elements of the source tensor at y=Val coordinate, where Val is the previously defined offset value.

As aforementioned, indexing mode bits 618 may control various indexing modes and indexing operations. Indexing mode bits 618 may indicate an axis (dimension) of the source tensor on which to apply an indexing offset. Also, indexing mode bits 618 may be used to disable indexing. Indexing mode bits 618 may further enable broadcasting of index tensor 610 in the Z (depth) dimension, or may enable broadcasting of index tensor 610 in the C (channel) dimension. Indexing mode bits 618 may also enable vector transpose applied on index tensor 610, e.g., conversion from a channel vector to a width vector. Additionally or alternatively, indexing mode bits 618 may set a maximum value of the indexing offset (e.g., represented with 16 bits).

Index broadcasting may set an index component in index tensor 610 (e.g., five-dimensional tuple I) for a specific axis to 0. When indexing mode bits 618 corresponding to broadcasting in C and Z dimensions are set to 0, index tensor fetching circuit 606 may fetch an index component from I[g, z, 0, 0, c], where g is an index component for a group dimension, z is an index component for a depth dimension and c is an index component for a channel dimension. Setting indexing mode bits 618 corresponding to broadcasting in C and Z dimensions to 1 causes index tensor fetching circuit 606 to fetch an index component from I[g, 0, 0, 0, 0]. Thus, the extent of index tensor 610 may be reduced in the broadcasted dimension(s) to one. The X (width) and Y (height) axes of index tensor 610 may be implicitly broadcasted.

Index tensor fetching circuit 606 may fetch non-broadcasted index components of index tensor 610 along a back-projected input dimension, with g=0, 1, . . . , NumGroups-1, z=0, 1, . . . , Din−1 and c=0, 1, . . . , Cin−1. If the fetched portion of source tensor (e.g., source surface 616) is itself broadcasted (e.g., if indexing mode bits 618 corresponding to source broadcasting along C or Z dimension are set), then Din or Cin may be reduced to one, and the extent of index tensor 610 in that dimension is reduced to one. Setting the source broadcasting (e.g., by the source broadcasting bits of indexing mode bits 618) causes that a single index component 614 from index tensor 610 is generated and replicated for fetching source surface 616. Setting the index broadcasting (e.g., by the index broadcasting bits of indexing mode bits 618) causes choosing whether a single index component 614 from index tensor 610 is going to be used as an origin of a slice of the source tensor in buffer memory 334, or whether a different index component 614 of index tensor 610 for each row is fetched from buffer memory 334. In the case of source broadcasting, one row of the source tensor may be fetched from buffer memory 334 as source surface 616. Note that C and Z axes may be fully general, and can be configured for multiple indexing modes (e.g., index broadcasting, source broadcasting, and/or indirection). X and Y axes may be configured only for the index broadcasting mode. G (group) axis may possess neither source broadcasting control nor index broadcasting control, and this G axis may be configured only for the indirection mode of operation. G axis may be implicitly non-broadcasted (e.g., for both the source tensor and the index tensor 610), although broadcasting can be simulated for either source tensor or index tensor 610 by explicitly setting indexing mode bits 618 corresponding to a group stride to 0. Setting the group stride to 0 may result into a normal source broadcasting.

Indexing along an index-broadcasted axis (e.g., X, Y, or optionally C or Z dimension) may shift a source range from x=0, 1, . . . , Win−1 by a value of Offset to x′=Offset, Offset+1, . . . , Offset+Win−1), where Offset is a smaller of the fetched index components (I[g, z, 0, 0, c]) or a maximum value of the indexing offset (MaxIndex). As aforementioned, the slicing may be required in X and Y axes, while the slicing may be optional for C and Z axes, and not available for G axis, whereas the result may be clamped to MaxIndex. In the case of indexing mode bits 618 defining source broadcast along X axis, source surface 616 fetched from buffer memory 334 may be reduced to x′=MaxIndex, MaxIndex+1, . . . MaxIndex+Win−1. MaxIndex may constrain the origin of the slice. If the fetched index component 614 in index tensor 610 was larger than MaxIndex, Offset may be clamped to MaxIndex and hence the slice would now become x′=MaxIndex, MaxIndex+1, . . . MaxIndex+Win−1. The extent of the underlying source tensor in the indexing axis may become Win′=Win+MaxIndex, assuming indexing along X axis is set by corresponding values of indexing mode bits 618. The extent of the source tensor may become MaxIndex+Win since the origin of the slice is clamped to MaxIndex. However, the extent of the slice may remain Win.

Indexing along a non-index-broadcasted axis (e.g., G, or optionally C or Z dimension) may be specially-treated to cause an indirection for each component, e.g., making c′=I[g, z, 0, 0, c]. In the case of source broadcasting in C axis, this type of indexing may produce c′=I[g, z, 0, 0, 0], which is the same result as in the case of index broadcasting. The extent of the underlying source tensor in the indexing axis may become Cin′=MaxIndex+1, assuming indexing along C axis is set by corresponding values of indexing mode bits 618.

Different indexing modes and indexing operations can be applied to different axes. While the index broadcasting may be implicitly set for the X and Y axes, the index broadcasting may be forbidden for the G axis. The index broadcasting may be configurable for the Z and C axes, e.g., based on corresponding values of indexing mode bits 618. Similarly as for the index broadcasting, the source broadcasting may be forbidden for the G axis. The source broadcasting may be configurable for the Z, X, Y and C axes, e.g., based on corresponding values of indexing mode bits 618. For each of C and Z axes, the type of indexing can be programmable, and the type of indirection can be indirection, slicing or broadcasting. For each of X and Y axes, the type of indexing can be broadcasting, and the type of indirection may be either slicing or broadcasting. For G axis, the type of indexing is non-broadcasting (e.g., indirection or slicing), and the type of indirection may be either indirection or broadcasting, e.g., if the group stride equals zero.

Planar engine 340 may support unary indexed operations. If indexing is enabled for a unary operation at planar engine 340 or for a unary reduction operation at planar engine 340, a first source may be fetched from buffer memory 334 as a portion of input data 342 using an indexing operation performed by indexing circuit 336. Registers in buffer memory 334 storing the first source may be resident or cached. Registers in buffer memory 334 storing a second source are resident and may be used for index components of index tensor 610. If index tensor 610 in buffer memory 334 is produced by a previous operation of planar engine 340 as output data 342 that are written back into buffer memory 334, then an alias may be used to enforce serialization between that previous operation and a next operation of planar engine 340 that uses index components of index tensor 610 to fetch input data 344 from buffer memory 334.

Alternatively or additionally, planar engine 340 may support binary indexed operations. If indexing is enabled for a binary operation at planar engine 340 or for a binary reduction operation at planar engine 340, a first source (Src1) may be fetched from buffer memory 334 as source surface 616 using an indexing operation performed by indexing circuit 336 to become a portion of input data 342 passed onto planar engine 340. A second source (Src2) may be fetched from buffer memory 334 as source surface 616 without an indexing operation, except that the second source may use addressing registers of the first source. In other words, the binary indexed operation may become Src1[Src2] OP Src1, where the first source is offset by index tensor 610, but the second source is not offset by index tensor 610. Each individual source may be associated with its own source broadcasting bits that may be part of, e.g., indexing mode bits 618.

In the case of binary indexed operations performed at planar engine 340, the addressing information may be shared for the two sources. A binary operation with indexing at planar engine 340 may be at least a three-source operation, e.g., a binary add between an indexed first source and a non-indexed second source: Src1[Idx[y]]+Src2[y], where Idx[y] is a corresponding index component 614 in index tensor 610. Thus, the binary operation with indexing may require three sources from buffer memory 334—the two sources Src1, Src2, and the index tensor Idx. In the case of two-port buffer memory 334, a binary operation with indexing may be instead implemented as, e.g., Src1[Idx[y]]+Src1[y] by sharing base pointers between the first source Src1 and the second source Src2. Alternatively or additionally, a binary operation with indexing may be implemented by utilizing indexing on both first and second sources, which would be a four-source operation, e.g., Src1[Idx1[y]]+Src2[Idx2[y]], where Idx1 is index tensor 610 for a first source Src1, Idx1[y] is a corresponding index component 614 in index tensor 610 for the first source, Idx2 is index tensor 610 for a second source Src1, and Idx2[y] is a corresponding index component 614 in index tensor 610 for the second source.

### Example Processes at Neural Engine Architecture

FIG. 7 is a flowchart illustrating a method of performing an indexing operation in a neural processor circuit, according to one embodiment. The neural processor circuit operates 702 at least one of neural engine circuits (e.g., at least one neural engine 314) in the neural processor circuit to perform a convolution operation on input data (e.g., input data 322) to generate output data (e.g., output data 328).

The neural processor circuit stores 704 an index tensor and the output data as a source tensor in a buffer memory (e.g., buffer memory 334) of a data processor circuit (e.g., data processor circuit 318) directly coupled to the at least one neural engine circuit. The index tensor may be generated by a planar engine circuit (e.g., planar engine 340) as a result of a reduction operation applied on at least a portion of the input data.

The neural processor circuit fetches 706, by an indexing circuit (e.g., indexing circuit 336) of the data processor circuit coupled to the buffer memory, a portion of the source tensor from the buffer memory by referencing the index tensor representing indexing information into the portion of the source tensor. In one or more embodiments, the neural processor circuit fetches, via the indexing circuit, elements of the source tensor along a dimension of the source tensor using a corresponding value in the index tensor. In one or more other embodiments, the neural processor circuit fetches, via the indexing circuit, a slice of the source tensor along a dimension of the source tensor starting from an offset value obtained from the index tensor, the slice being of a size that fits into the buffer memory.

Embodiments of the process as described above with reference to FIG. 7 are merely illustrative. Moreover, sequence of the process may be modified or omitted.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit, comprising:
a plurality of neural engine circuits, at least one of the neural engine circuits configured to perform a convolution operation on input data to generate output data; and
a data processor circuit directly coupled to the at least one neural engine circuit, the data processor circuit comprising:
a buffer memory configured to store an index tensor and the output data as a source tensor, and
an indexing circuit coupled to the buffer memory, the indexing circuit configured to fetch a portion of the source tensor from the buffer memory by referencing the index tensor representing indexing information into the portion of the source tensor.

2. The neural processor circuit of claim 1, wherein the indexing circuit is further configured to fetch elements of the source tensor along a dimension of the source tensor using a corresponding value in the index tensor.

3. The neural processor circuit of claim 2, wherein the data processor circuit is further configured to broadcast the fetched elements of the source tensor to the plurality of neural engine circuits.

4. The neural processor circuit of claim 2, wherein the data processor circuit further comprises a formatting circuit coupled to the indexing circuit, the formatting circuit configured to:
transpose the fetched elements of the source tensor to generate a transposed version of the source tensor.

5. The neural processor circuit of claim 1, wherein the indexing circuit is further configured to fetch a slice of the source tensor along a dimension of the source tensor starting from an offset value obtained from the index tensor, the slice being of a size that fits into the buffer memory.

6. The neural processor circuit of claim 5, wherein the data processor circuit is further configured to broadcast the fetched slice of the source tensor to the plurality of neural engine circuits.

7. The neural processor circuit of claim 1, wherein the data processor circuit further comprises a formatting circuit coupled to the indexing circuit, the formatting circuit configured to:
transpose the fetched slice of the source tensor to generate a transposed version of the source tensor.

8. The neural processor circuit of claim 1, further comprising a planar engine circuit directly coupled to the data processor circuit, the planar engine circuit configured to:
generate the index tensor as a result of a reduction operation applied on at least a portion of the input data; and
store the generated index tensor into the buffer memory.

9. The neural processor circuit of claim 1, wherein the data processor circuit further comprises a formatting circuit coupled to the indexing circuit, the formatting circuit configured to:
receive the fetched portion of the source tensor from the indexing circuit; and
perform formatting and aligning of the fetched portion of the source tensor to generate an aligned version of the source tensor for the at least one neural engine circuit.

10. The neural processor circuit of claim 9, further comprising a planar engine circuit directly coupled to the data processor circuit, the planar engine circuit configured to:
receive the aligned version of the source tensor;
perform a planar operation on at least a portion of the aligned version of the source tensor to generate a planar version of the source tensor; and
write back the planar version of the source tensor into the buffer memory.

11. The neural processor circuit of claim 9, wherein the at least one neural engine circuit is further configured to:
receive the aligned version of the source tensor;
perform another convolution operation on at least a portion of the aligned version of the source tensor to generate a processed version of the source tensor; and
write back the processed version of the source tensor into the buffer memory.

12. A method of operating a neural processor circuit, comprising:
operating at least one of a plurality of neural engine circuits in the neural processor circuit to perform a convolution operation on input data to generate output data;
storing an index tensor and the output data as a source tensor in a buffer memory of a data processor circuit directly coupled to the at least one neural engine circuit; and
fetching, by an indexing circuit of the data processor circuit coupled to the buffer memory, a portion of the source tensor from the buffer memory by referencing the index tensor representing indexing information into the portion of the source tensor.

13. The method of claim 12, further comprising:
fetching elements of the source tensor along a dimension of the source tensor using a corresponding value in the index tensor; and
broadcasting the fetched elements of the source tensor to the plurality of neural engine circuits.

14. The method of claim 12, further comprising:
fetching elements of the source tensor along a dimension of the source tensor using a corresponding value in the index tensor; and
transposing the fetched elements of the source tensor to generate a transposed version of the source tensor.

15. The method of claim 12, further comprising:
fetching a slice of the source tensor along a dimension of the source tensor starting from an offset value obtained from the index tensor, the slice being of a size that fits into the buffer memory; and
broadcasting the fetched slice of the source tensor to the plurality of neural engine circuits.

16. The method of claim 12, further comprising:
fetching a slice of the source tensor along a dimension of the source tensor starting from an offset value obtained from the index tensor, the slice being of a size that fits into the buffer memory; and
transposing the fetched slice of the source tensor to generate a transposed version of the source tensor.

17. The method of claim 12, further comprising:
performing formatting and aligning of the fetched portion of the source tensor to generate an aligned version of the source tensor.

18. The method of claim 17, further comprising:
receiving, at a planar engine circuit directly coupled to the data processor circuit, the aligned version of the source tensor;
performing, by the planar engine circuit, a planar operation on at least a portion of the aligned version of the source tensor to generate a planar version of the source tensor; and
writing back, by the planar engine circuit, the planar version of the source tensor into the buffer memory.

19. An electronic device, comprising:
a system memory storing input data; and
a neural processor circuit coupled to the system memory, the neural processor circuit including:
a data processor circuit configured to receive the input data from the system memory,
a plurality of neural engine circuits coupled to the data processor circuit, at least one of the neural engine circuits directly coupled to the data processor circuit and configured to perform a convolution operation on at least a portion of the input data from the data processor circuit to generate output data, the data processor circuit comprising:
a buffer memory configured to store an index tensor and the output data as a source tensor, and
an indexing circuit coupled to the buffer memory, the indexing circuit configured to fetch a portion of the source tensor from the buffer memory by referencing the index tensor representing indexing information into the portion of the source tensor.

20. The electronic device of claim 19, wherein:
the indexing circuit is further configured to fetch a slice of the source tensor along a dimension of the source tensor starting from an offset value obtained from the index tensor; and
the data processor circuit further comprising a formatting circuit coupled to the indexing circuit, the formatting circuit configured to transpose the fetched slice of the source tensor to generate a transposed version of the source tensor.
